(19) United States
(12) Patent Application Publication
(10) Pub. No.: US 2011/0216361 A1
(43) Pub. Date: Sep. 8, 2011

(54) COMPUTER-READABLE RECORDING MEDIUM HOLDING A PRINTER DRIVER, PRINTING CONTROL APPARATUS, AND COMPUTER-READABLE RECORDING MEDIUM HOLDING A PRINTER SEARCH PROGRAM

(75) Inventors: Satoru NAKAYAMA, Shiojiri-shi (JP); Shuji WAKUMOTO, Matsumoto-shi (JP); Noriyuki TAKEI, Shiojiri-shi (JP)

(73) Assignee: SEIKO EPSON CORPORATION, Tokyo (JP)

(21) Appl. No.: 13/039,696

(22) Filed: Mar. 3, 2011

(30) Foreign Application Priority Data
Mar. 8, 2010 (JP) 2010-050576

(51) Int. Cl. G06F 3/12

(52) U.S. Cl. 358/1.15

(57) ABSTRACT

A printer driver searches for local printers connected to a computer and network printers connected via a network to the computer by including the local printers and network printers in a search criteria. In the case where a local printer has been found, the local printer is selected as a printer that is to execute printing.

The entire disclosure of Japanese Patent Application No. 2010-050576, filed Mar. 8, 2010 is expressly incorporated by reference herein.

### BACKGROUND

1. Technical Field

The present invention relates to techniques for searching out printing apparatuses such as printers, copy machines, complex machines, and so on.

2. Related Art

A printer driver capable of searching out multiple types of printers (for example, printers that support specific types of page description language) over a network and causing a printer selected from among the search results to execute printing (such a printer driver is called, for example, a “common driver”) is known (for example, see JP-A-2002-91732). If such a printer driver is installed in, for example, a terminal such as a mobile PC or the like, it is easy to discover printers for executing printing even if the terminal itself has moved.

Incidentally, with an OS (operating system), a printer driver, or the like that includes a network search function for printers, a printer that is directly connected to the terminal via USB or the like (such a printer is called, for example, a “local printer”) is not searched out.

However, in the case where a local printer is connected to the terminal, it can be assumed that a user would rather use the local printer than a printer on the network. Accordingly, the technique described above is inconvenient for the user. Note also that although the local printer can be used by manually setting an output port, launching a different printer driver, or the like, this is also inconvenient for the user.

### SUMMARY

An advantage of some aspects of the invention is to increase the convenience for a user when searching out printers.

A first aspect of the invention is a printer driver that causes a computer to function as a printing control apparatus for searching out a printer including: a search unit that performs a search for local printers connected to the computer and network printers connected via a network to the computer by including the local printers and network printers in a search criteria; and a selection unit that, in the case where a local printer has been found, selects the local printer as a printer that is to execute printing.

Here, in the stated printer driver, it is preferable that the search unit search for local printers before searching for network printers.

Furthermore, it is preferable that the stated printer driver cause the computer to function as an apparatus further including a search range acceptance unit that accepts a selection as to whether or not to include local printers in the search criteria, and in the case where a selection has been made not to include local printers in the search criteria, the search unit search for network printers by including the local printers and network printers in the search criteria.

Furthermore, it is preferable that any of the stated printer drivers cause the computer to function as an apparatus further including a mode acceptance unit that accepts a setting for a mode that treats local printers with preference, and in the case where the mode has been set, the search unit end the search in the case where a local printer has been found.

A second aspect of the invention is a printing control apparatus that searches for printers, the apparatus including: a search unit that performs a search for local printers connected to a computer and network printers connected via a network to the computer by including the local printers and network printers in a search criteria; and a selection unit that, in the case where a local printer has been found, selects the local printer as a printer that is to execute printing.

A third aspect of the invention is a printer search program that searches for printers, the program causing a computer to function as an apparatus including: a search unit that performs a search for local printers connected to a computer and network printers connected via a network to the computer by including the local printers and network printers in a search criteria; and a selection unit that, in the case where a local printer has been found, selects the local printer as a printer that is to execute printing.

### BRIEF DESCRIPTION OF THE DRAWINGS

The invention will be described with reference to the accompanying drawings, wherein like numbers reference like elements.

FIG. 1 is a diagram illustrating the overall hardware configuration of a printing system embodying the invention.

FIG. 2 is a block diagram illustrating an example of the functional configuration of a host computer.

FIG. 3 is a diagram illustrating an example of a printer selection window through which a printer is selected.

FIG. 4 is a diagram illustrating an example of an extension setting window through which printer driver extension settings are accepted.

FIG. 5 is a flowchart illustrating an example of a printer selection process.

### DESCRIPTION OF EXEMPLARY EMBODIMENTS

Hereinafter, an embodiment of the invention will be described with reference to the drawings.

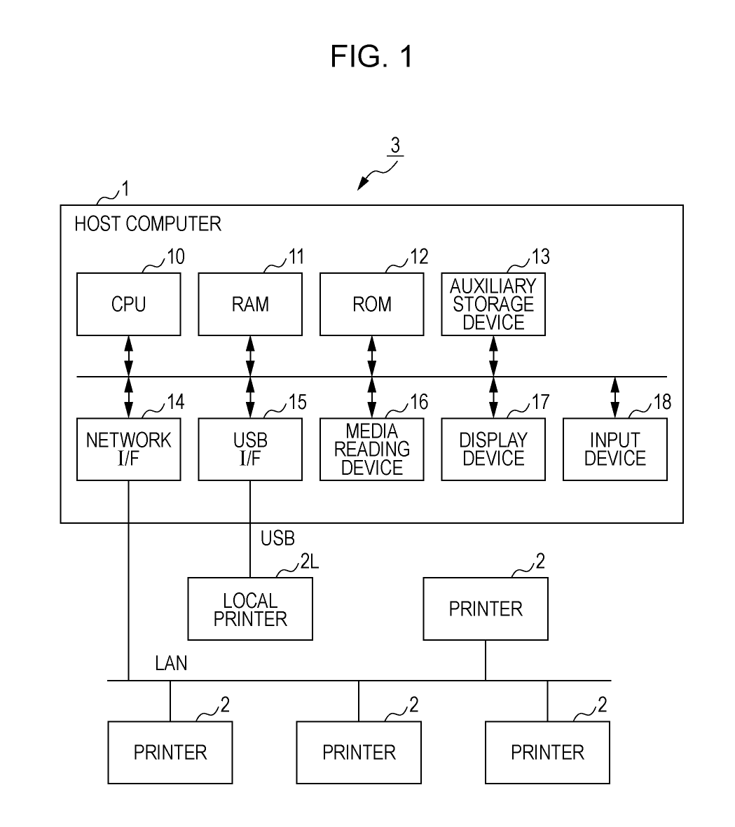

FIG. 1 is a diagram illustrating the overall hardware configuration of a printing system 3 embodying the invention.

The printing system 3 includes a host computer 1 that functions as a printing control apparatus, and printers 2 and a local printer 2L that function as printing apparatuses. The host computer 1 is connected to the printers 2 via a network such as, for example, a wired LAN, a wireless LAN, or the like. Meanwhile, the host computer 1 and the local printer 2L are directly connected via, for example, USB, a parallel connection, wireless communication, or the like.

A printer driver, mentioned later, that has a function for searching out usable printers 2 located on the network and a usable local printer 2L is installed in the host computer 1, and controls the printing carried out by a selected printer. The printers 2 and the local printer 2L execute printing based on print data in a format such as PDL that has been sent from the host computer 1.

The host computer 1 includes, for example: a CPU 10 that carries out various types of operations; a RAM 11 that stores programs executed by the CPU 10, data, and so on; a ROM 12 that stores, in advance, programs, data, and so on necessary when starting up the host computer 1; an auxiliary storage device 13 such as an HDD (Hard Disk Drive), a SSD (Solid-State Drive), or the like; a network interface (I/F) 14 that connects with a network such as a wired LAN or the like and carries out communication; a USB interface (I/F) 15 that carries out communication through USB; a media reading device 16 that reads out information from a portable storage medium such as a CD-ROM or the like; a display device 17, such as an LCD or the like, that displays user interface (UI) windows and the like; and an input device 18 such as a keyboard, a mouse, or the like.

The printers 2 and the local printer 2L have, for example, laser or ink jet printing mechanisms, and print in color or black and white. Of course, the type of printing is not limited to those mentioned here.

The configurations of the printing system 3, the host computer 1, the printers 2, and the local printer 2L described above include the primary configurations necessary for describing the features of the invention, and are not intended to be limited to the configurations described above. These configurations are also not intended to exclude configurations that include typical printing systems, host computers, and printers. For example, multiple local printers 2L may be connected to the host computer 1.

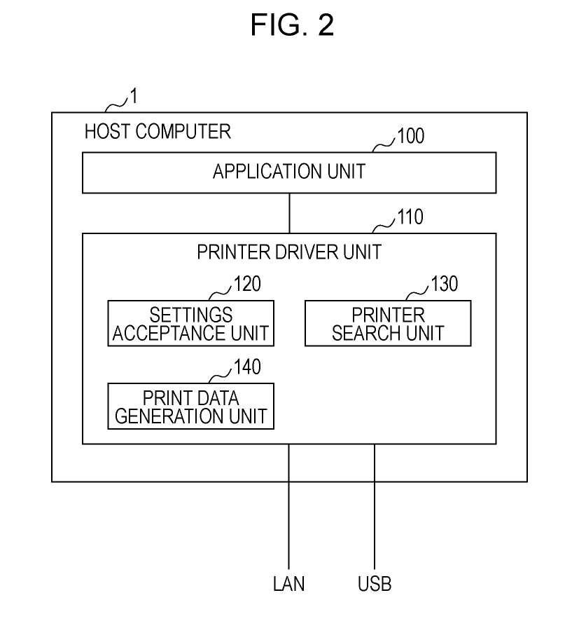

FIG. 2 is a block diagram illustrating an example of the functional configuration of the host computer 1.

The host computer 1 includes an OS (operating system) unit (not shown), an application unit 100, and a printer driver unit 110.

The OS unit and the application unit 100 are realized by, for example, the CPU 10 executing a predetermined OS program and application program loaded from the auxiliary storage device 13 into the RAM 11. The printer driver unit 110 is realized by, for example, the CPU 10 executing a predetermined printer driver program loaded from the auxiliary storage device 13 into the RAM 11.

Note that the printer driver program can, for example, be downloaded from a server on a network such as the Internet and installed in the host computer 1 or updated. The printer driver program may also be read from a storage medium such as a CD-ROM by the media reading device 16 or read from a storage medium such as a flash ROM or the like by the USB interface 15, and installed in the host computer 1 or updated.

The OS unit has what is known as a basic software function, which provides system management and a basic user operation environment for the host computer 1. The application unit 100 and the printer driver unit 110 are implemented under the management of the OS unit.

The application unit 100 has what is known as an application software function for providing, to the user, a specific function in accordance with one of various types of purposes. In this embodiment, the application unit 100 carries out processes such as, for example, the creation, display, editing, and so on of document files, image files, or the like.

Furthermore, the application unit 100 receives, via a predetermined UI window, an instruction to print a file (data to be printed) selected by the user. Upon receiving the print instruction, the application unit 100 instructs the printing to be carried out by communicating the data to be printed along with received print settings to the printer driver unit 110.

The printer driver unit 110 performs a process for searching out usable printers on the network and usable local printers and controlling a selected printer in order to carry out printing. The printer driver unit 110 carries out processes such as, for example, a process for controlling the display of various types of printer driver UI windows, a process for controlling the user's input operations via the UI window, a process for generating print data based on the data to be printed received from the application unit, a process for sending the print data to a printer and causing the printer to execute printing, and so on.

Furthermore, in this embodiment, the printer driver unit 110 is capable of handling multiple printers, and thus carries out processes, such as a process for searching out printers and local printers that can be used by the host computer 1, a process for accepting the selection of a printer that is to execute printing, and so on.

In order to realize the aforementioned processes, the printer driver unit 110 includes a settings acceptance unit 120, a printer search unit 130, and a print data generation unit 140.

Although the main processes such as the acceptance of print settings, the searching out of printers, the selection of a printer, and the generation of print data are implemented by a printer driver program in this embodiment, it should be noted that processes related to, for example, the searching out of printers and the selection of a printer may be implemented by a printer search program that can be linked to the printer driver program.

The settings acceptance unit 120 displays a predetermined UI window in the display device 17, and accepts, via the input device 18, the selection of a printer, an instruction to search out printers, search condition settings for local printers, print settings, and so on. The settings acceptance unit 120 also accepts printing instructions, and then sends data to be printed and various types of print settings to the print data generation unit 140.

In the case where the settings acceptance unit 120 has, for example, accepted an instruction to make print settings or an instruction to execute printing due to user operations made via a predetermined UI window displayed by the OS unit or the application unit 100, the settings acceptance unit 120 displays a predetermined UI window for accepting instructions to search out and select a printer that is to execute printing, and accepts the selection of the printer.

In addition, in the case where the settings acceptance unit 120 has, for example, accepted an instruction to make print settings due to user operations made via a predetermined UI window displayed by the OS unit or the application unit 100, the settings acceptance unit 120 displays a predetermined UI window for accepting the print settings, printer driver extension settings, and so on, and accepts those settings.

Note that the timing at which the settings acceptance unit 120 displays the predetermined UI window and accepts the various types of print settings, printer driver extension settings, and so on may be, for example, prior to the acceptance of an instruction to execute printing or after the acceptance of an instruction to execute printing. The processing related to the acceptance of print settings is not a primary function, and thus descriptions thereof will be omitted from this embodiment.

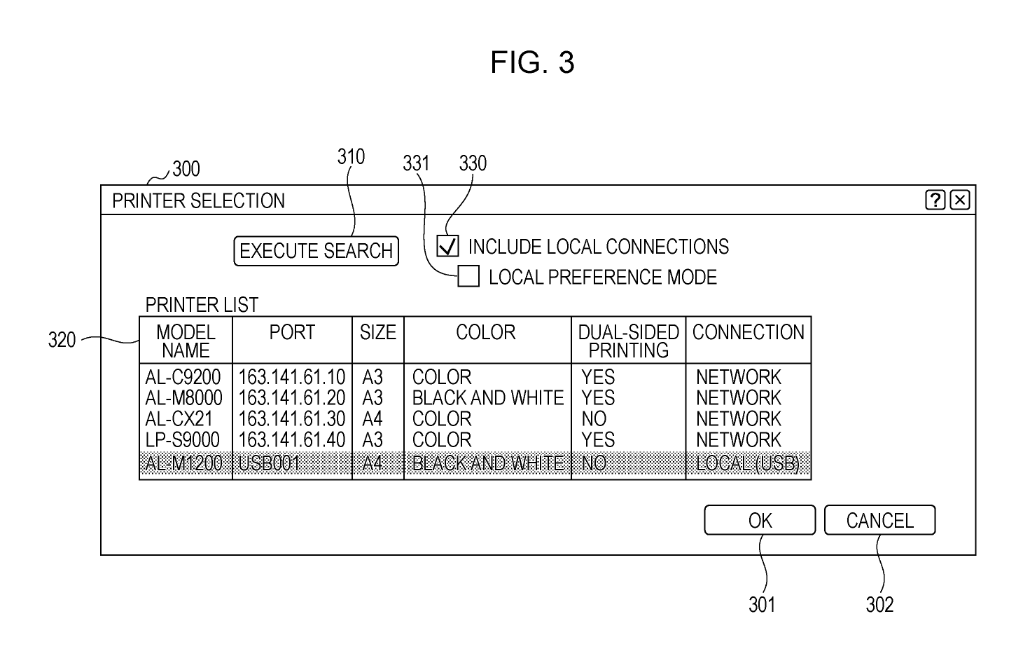

To be more specific, the settings acceptance unit 120 displays, for example, the UI window shown in FIG. 3. FIG. 3 is a diagram illustrating an example of a printer selection window 300 through which a printer is selected.

As shown in FIG. 3, the printer selection window 300 includes: a search execute button 310 for executing a printer search; a search result display region 320 for displaying the printer search results as a list; a local connection specification checkbox 330 for specifying a local printer to be included in the search criteria; a local connection preference mode checkbox 331 for making a setting specifying that a local printer is to be searched out first and used as the printer that is to execute printing (that is, the port through which print data is outputted); an OK button 301 for setting the printer selected in the search result display region 320 as the printer that is to execute printing (that is, the port through which print data is outputted); and a cancel button 302 for canceling the settings. Note that in the case where the local connection specification checkbox 330 has been selected, the local connection preference mode checkbox 331 is activated so that the user can select that checkbox.

Upon accepting the selection of the search execute button 310, the settings acceptance unit 120 requests the printer search unit 130 to execute a search process for printers that can be used by the host computer 1. The search conditions set in the local connection specification checkbox 330 and the local connection preference mode checkbox 331 are also sent with the request by the printer search unit 130. Note that the search may be executed automatically when the printer selection window 300 is displayed.

In the case where the printer search process performed by the printer search unit 130 has ended, the settings acceptance unit 120 obtains the search results from the printer search unit 130 and displays those results in the search result display region 320.

The search results are configured as an entry list in which, for example, the following pieces of information are associated with each other: the printer model name; the port; the size of the paper that can be printed on; the colors that can be printed (in other words, color or black and white); whether or not dual-sided printing is supported; the type of connection to the host computer 1 (network or local); and so on. Of course, the configuration of the search results is not limited thereto, and may also include information indicating, for example, the status of the printer (printing, idling, toner amounts, and so on).

The settings acceptance unit 120 accepts, though user operations, the selection of one of the entries in the printer list displayed in the search result display region 320 as described above. The selection of an entry can be carried out by moving a cursor (indicated by the shaded region in FIG. 3).

In the case where the selection of the OK button 301 has been accepted, the settings acceptance unit 120 specifies a printer corresponding to the entry selected in the search result display region 320 as the printer that is to execute printing (that is, the port through which print data is outputted). The print data generation unit 140 is then instructed to send the print data to the specified printer. Finally, the printer selection window 300 is closed.

Note that in the case where the local connection preference mode checkbox 331 is selected (that is, when in a local connection preference mode), the settings acceptance unit 120 obtains the entry of a local printer searched out by the printer search unit 130 and displays that entry in the search result display region 320. In this case, the printer selection window 300 may be closed without displaying the local printer entry assuming that the local printer corresponding to that entry has been selected.

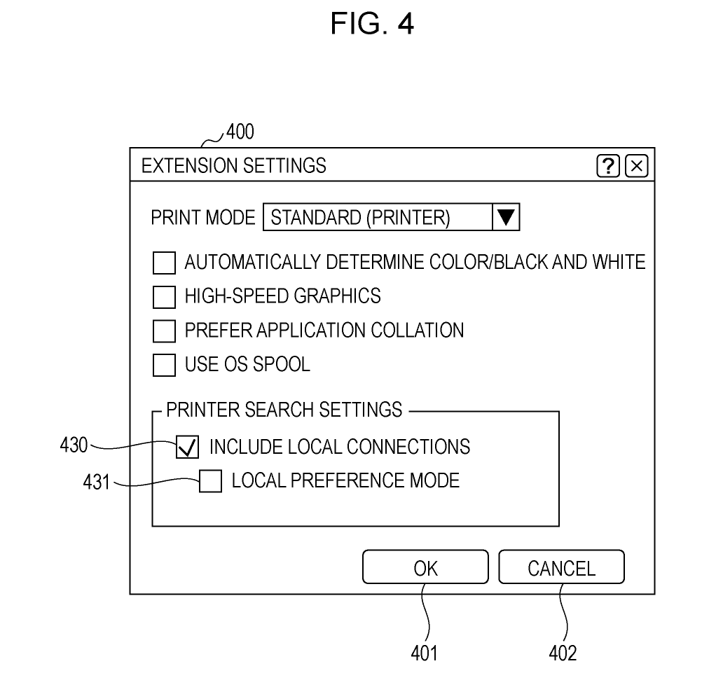

In addition, the settings acceptance unit 120 displays, for example, the UI window shown in FIG. 4. FIG. 4 is a diagram illustrating an example of an extension setting window 400 through which printer driver extension settings are received.

Note that the settings acceptance unit 120 can display the extension setting window 400 by accepting the instruction of the printer driver extension settings from, for example, a predetermined UI window for making print settings.

As shown in FIG. 4, the extension setting window 400 includes, in addition to checkboxes for making various types of settings regarding the printer driver, a local connection specification checkbox 430 for specifying the local printer to be included in the search criteria; a local connection preference mode checkbox 431 for making a setting specifying that a local printer is to be searched out first and used as the printer that is to execute printing; an OK button 401 for setting the various types of extension settings specified in the extension setting window 400 as the extension settings to be used in printing; and a cancel button 402 for canceling the settings. In the case where the local connection specification checkbox 430 has been selected, the local connection preference mode checkbox 431 is activated so that the user can select that checkbox.

Before displaying the printer selection window 300, the settings acceptance unit 120 refers to the settings in the extension setting window 400 as the default settings, and carries out the control thereafter. For example, in the case where the local connection specification checkbox 430 is selected, the settings acceptance unit 120 displays the printer selection window 300 with the local connection specification checkbox 330 selected. Likewise, in the case where the local connection preference mode checkbox 431 is selected, the settings acceptance unit 120 displays the printer selection window 300 with the local connection preference mode checkbox 331 selected.

Note that in the case where the local connection preference mode checkbox 431 is selected, the settings acceptance unit 120 may request the printer search unit 130 to search out printers without displaying the printer selection window 300 after accepting a printing instruction. In this case, the settings acceptance unit 120 automatically selects the local printer obtained in the search results as the output port and instructs the print data generation unit 140 to carry out the printing process.

The configurations, display formats, control methods, and so on of the various UI windows described above have been given as examples for facilitating understanding of the configuration of the printer driver unit 110. Accordingly, the configurations, display formats, control methods, and so on of the various UI windows described above are not intended to limit the invention in any way. For example, the various windows can all be displayed as a single window. Furthermore, the windows may, for example, be split up into more windows.

Returning to FIG. 2, the printer search unit 130 searches out printers that can be used by the host computer 1. The printer search unit 130 obtains printer information from the printers, creates a printer list based on that information, and stores that printer list in the RAM 11, the auxiliary storage device 13, or the like as the search results.

Printer information that can be collected from the printers includes, for example: information for identifying the printers 2 connected to the network (an IP address, a MAC address, a product model name, or the like); information indicating the functions of the printers 2 (the number of paper supply units, the size of the paper that is supplied, whether or not a dual-sided printing mechanism is present, and so on); information indicating the status of the printers 2 (idling, printing, a toner amount, or the like); and so on. Note that information indicating whether or not a local printer is connected to the host computer 1 can also be obtained by, for example, inquiring with the OS unit.

When performing the search process, the printer search unit 130 obtains, from the settings acceptance unit 120, the search conditions set in the printer selection window 300 (FIG. 3) or the extension setting window 400 (FIG. 4) (that is, whether or not the local connection specification checkbox has been checked and whether or not the local connection preference mode checkbox has been checked). The printer search unit 130 then executes the search process based on those search conditions.

In the case where the local connection specification checkbox 330 or 430 is checked, the printer search unit 130 searches out printers that can be used by the host computer 1, including, in the search criteria, the local printer 2L in addition to the printers 2 that are located on the network.

Meanwhile, in the case where the local connection preference mode checkbox 331 or 431 is checked, the printer search unit 130 executes a search process for a local printer without carrying out a search process for printers that are located on the network. In the case where a local printer has been found, the printer information is obtained from the local printer, and the search results are generated based on the obtained printer information.

The print data generation unit 140 then generates the print data based on the print settings sent from the settings acceptance unit 120 and the data to be printed specified by the application unit 100. In addition, the print data generation unit 140 sends the generated print data to the printers 2 that are located on the network or the local printer 2L specified by the settings acceptance unit 120.

To be more specific, the print data generation unit 140 accepts the print instruction from the settings acceptance unit 120, and obtains the print settings (these include, for example, the print settings applied through the predetermined UI window of the settings acceptance unit 120 and the print settings specified through the application unit 100) from the settings acceptance unit 120. In addition, the print generation unit 140 obtains the data to be printed, specified by the application unit 100, from the settings acceptance unit 120. The print generation unit 140 then converts the obtained data into print data based on the print settings. Finally, the print generation unit 140 sends the print data to the printer selected in the printer selection window 300, or to the specified local printer without going through the printer selection window 300.

The aforementioned constituent elements have been classified according to the details of the main processes they perform in order to facilitate understanding of the configuration of the host computer 1. The invention is not intended to be limited by the method for classifying the constituent elements nor by the naming thereof. The configuration of the host computer 1 can be classified into further groups of constituent elements in accordance with the details of the processes performed thereby. Furthermore, a single constituent element may be classified so as to execute more processes. Finally, the processes of each constituent element may be executed by a single piece of hardware, or may be executed by multiple pieces of hardware.

Next, a characteristic process realized by the aforementioned host computer 1 will be described.

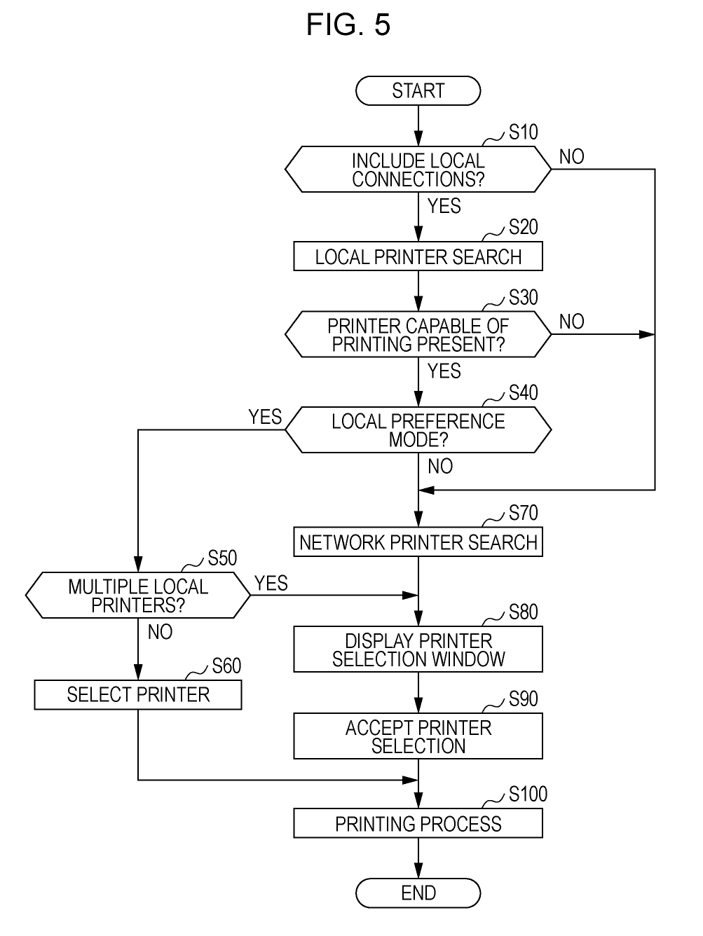

FIG. 5 is a flowchart illustrating an example of a printer selection process. This flow is started when, for example, the printer driver unit 110 has received an instruction to make print settings or an instruction to start printing from the application unit 100. The instruction to make print settings or the instruction to start printing is executed through, for example, a printing UI window of the application unit 100. Note that this flow is controlled so that, in the case where the local preference mode has been set, the printer selection window 300 is not displayed except in certain predetermined situations.

In S10, the printer search unit 130 determines whether or not the search criteria includes local connections. Specifically, the printer search unit 130 obtains the search conditions from the print settings acceptance unit 120 and determines whether or not the local connection specification checkbox 430 in the extension setting window 400 is checked. In the case where the local connection specification checkbox 430 is checked (S10: YES), the process advances to S20. However, in the case where the local connection specification checkbox 430 is not checked (S10: NO), the process advances to S70.

In S20, the printer search unit 130 searches out local printers. Specifically, the printer search unit 130 determines whether or not a local printer is connected to the host computer 1. In the case where a local printer is connected, the printer information is obtained from the local printer, and the search results are generated based on that printer information. The process then advances to S30.

In S30, the printer search unit 130 determines whether or not a local printer capable of printing is present. Specifically, the printer search unit 130 determines, in the case where search results have been generated in S20, that a local printer is present. In the case where a local printer is present (S30: YES), the process advances to S40. However, in the case where a local printer is not present (S30: NO), the process advances to S70.

In S40, the printer search unit 130 determines whether or not the local preference mode is set. Specifically, the printer search unit 130 obtains the search conditions from the print settings acceptance unit 120 and determines whether or not the local connection preference mode checkbox 431 in the extension setting window 400 is checked. In the case where the local connection preference mode checkbox 431 is checked (S40: YES), the process advances to S50. However, in the case where the local connection preference mode checkbox 431 is not checked (S40: NO), the process advances to S70.

In S50, the settings acceptance unit 120 determines whether or not multiple local printers are present. Specifically, the settings acceptance unit 120 obtains the search results from the printer search unit 130 and determines whether or not multiple local printers are present based on those search results. In the case where multiple local printers are not present, or in other words, the case where only one is present (S50: NO), the process advances to S60. However, in the case where multiple local printers are present (S50: YES), the process advances to S80.

In S60, the settings acceptance unit 120 selects a printer to carry out printing. Specifically, the local printer searched out in S20 is selected as the output port. The process then advances to S100.

In S70, the printer search unit 130 searches out a network printer. Specifically, the printer search unit 130 searches out usable printers located on the network, obtains the printer information from those printers, and generates search results based on the obtained printer information. The process then advances to S80.

In S80, the settings acceptance unit 120 displays the printer selection window 300. Specifically, in the case where the local preference mode is set (S40: YES; S50: YES), the settings acceptance unit 120 obtains the search results including the multiple local printers searched out in S20 from the printer search unit 130 and displays those search results as a list in the search result display region 320. However, in the case where network printers have been searched out in S70, the settings acceptance unit 120 obtains, from the printer search unit 130, the search results for the network printers and, if available, the search results for the local printers, and displays those search results as a list in the search result display region 320. The process then advances to S90.

In S90, the settings acceptance unit 120 accepts the selection of a printer. Specifically, the settings acceptance unit 120 accepts the selection of a printer from the printer list displayed in the search result display region 320. The selected printer is set as the output port when the OK button 301 has been pressed, after which the process advances to S100.

In S100, the print data generation unit 140 executes the printing process. Specifically, in the case where this processing flow has been started due to an instruction to make print settings, for example, the printing process is started after an instruction to start printing has been made to the settings acceptance unit 120 from the application unit 100. On the other hand, in the case where this processing flow has been started due to an instruction to start printing, the printing process is started without waiting for an instruction to start printing from the application unit 100. The print data generation unit 140 then generates the print data based on the print settings sent from the settings acceptance unit 120 and the data to be printed specified by the application unit 100. The print data is then sent to the printer selected in S60 or S90. After this, the processing flow ends.

The above description of the processing flow illustrates the main processing flow as a way to illustrate a feature of the invention, and is not intended to exclude other processes. The processing units of the aforementioned flow have been divided up according to the primary processing details thereof in order to facilitate understanding of the processes performed by the host computer 1. The invention is not intended to be limited by the method for dividing the processing units nor by the naming thereof. The processing performed by the host computer 1 can be divided into further processing units in accordance with the details of those processes. Furthermore, a single processing unit may be divided so as to include more processes.

An exemplary embodiment of the invention has been described thus far. According to this embodiment, it is possible to increase the convenience for a user when searching out printers.

In other words, according to this embodiment, local printers can be included in the search criteria. Furthermore, a local printer can be searched out first, and that local printer can then be set as the output port. Through this configuration, printing can be executed using the user's desired local printer in a short amount of time, which improves the convenience for the user.

The aforementioned embodiment of the invention is intended to illustrate an example of the spirit and scope of the invention, and is not intended to limit the invention in any way. Many substitutions, modifications, and variations will be apparent to those skilled in the art.

Note also that the invention can also be applied in printing systems that include printing apparatuses such as copy machines, complex machines and so on having printer functions, in addition to printers.

What is claimed is:

1. A computer-readable recording medium on which is recorded a printer driver that causes a computer to function as an apparatus comprising:
a search unit that performs a search for local printers connected to the computer and network printers connected via a network to the computer by including the local printers and network printers in a search criteria; and
a selection unit that, in the case where a local printer has been found, selects the local printer as a printer that is to execute printing.

2. The computer-readable recording medium on which is recorded a printer driver according to claim 1,
wherein the search unit searches for local printers before searching for network printers.

3. The computer-readable recording medium on which is recorded a printer driver according to claim 1,
wherein the printer driver causes a computer to function as an apparatus that includes a search range acceptance unit that accepts a selection as to whether or not to includes local printers in the search criteria and, in the case where a selection has been made not to include local printers in the search criteria, the search unit searches for network printers by including the local printers and network printers in the search criteria.

4. The computer-readable recording medium on which is recorded a printer driver according to claim 1,
wherein the printer driver causes a computer to function as an apparatus that includes a mode acceptance unit that accepts a setting for a mode that treats local printers with preference, and in the case where the mode has been set, the search unit ends the search in the case where a local printer has been found.

5. A printing control apparatus that searches for printers, the apparatus comprising:
a search unit that performs a search for local printers connected to a computer and network printers connected via a network to the computer; and
a selection unit that, in the case where a local printer has been found, selects the local printer as a printer that is to execute printing.

6. A computer-readable recording medium on which is recorded a printer search program that searches for printers,
wherein the printer search program causes a computer to function as an apparatus that includes:
a search unit that performs a search for local printers connected to a computer and network computers connected via a network to the computer; and
a selection unit that, in the case where a local printer has been found, selects the local printer as a printer that is to execute printing.
